(19) United States
(12) Patent Application Publication
(10) Pub. No.: US 2018/0283244 A1
(43) Pub. Date: Oct. 4, 2018

(54) OIL STRAINER AND POWER TRANSMISSION DEVICE

(71) Applicant: HONDA MOTOR CO., LTD., Tokyo (JP)

(72) Inventors: Sachi FUJINUMA, Wako (JP); Kenji NIWATA, Wako (JP); Satoshi IMAMORI, Wako (JP)

(73) Assignee: HONDA MOTOR CO., LTD., Tokyo (JP)

(21) Appl. No.: 15/891,369

(22) Filed: Feb. 8, 2018

(30) Foreign Application Priority Data
Mar. 30, 2017 (JP) 2017-069159

(51) Int. Cl. F01M 11/03; F16H 57/04

(52) U.S. Cl. CPC F01M 11/03; F01M 2011/007; F16H 57/0404

(57) ABSTRACT

An oil strainer includes a main body, a tubular suction protrusion, and a partition. The main body has a bottom and is configured to filter an oil in an oil storage. The tubular suction protrusion protrudes from the bottom of the main body downward in a height direction along a height of the oil storage and has a suction port at a bottom end of the tubular suction protrusion. The main body is configured to suction the oil in the oil storage via the suction port. The partition protrudes downward in the height direction from the bottom of the main body and is provided apart from the suction port.

### CROSS-REFERENCE TO RELATED APPLICATIONS

The present application claims priority under 35 U. S. C. § 119 to Japanese Patent Application No. 2017-069159, filed Mar. 30, 2017. The contents of this application are incorporated herein by reference in its entirety.

### BACKGROUND OF THE INVENTION

### Field of the Invention

The present invention relates to an oil strainer and a power transmission device.

### Discussion of the Background

Oil used as operating oil or lubricating oil in a power transmission device such as a differential mechanism and a transmission provided in an automobile is stored in an oil storage part provided at the bottom section of a casing of the power transmission device. The oil stored in the oil storage part is suctioned by an oil pump to be supplied to a transmission mechanism or the like and it is flowed back to the oil storage part after used as the operating oil or the lubricating oil in the transmission mechanism or the like to which the oil was supplied.

The oil storage part is provided with an oil strainer for straining the oil that is sucked up by the oil pump (refer to Japanese Published Unexamined Application No. 2011-12774). The oil strainer is provided with a hollow container-shaped main body which houses a filtering member (a filter) therein, and a suction section for sucking the oil into the main body. When the oil pump installed on the downstream side of the oil strainer is activated, the oil stored in the oil storage part is discharged from the oil strainer after suctioned and strained by the oil strainer and then sent to the oil pump.

In the meanwhile, there is a case where the power transmission device such as the differential mechanism and the transmission is provided with a gear of which at least the part is immersed in the oil within the oil storage part. In this case, when the oil in the oil storage part is stirred by the rotation of the gear, air bubbles (air) are mixed into the oil. Also, when the oil in the oil storage part is stirred, turbulence of the oil flow is likely to occur. When that happens, the oil in which air bubbles are mixed or the oil that caused turbulence of the flow is suctioned by the oil strainer and sent to the oil pump. Then, in the oil pump, there is a probability that abnormal vibration or pulsation (the so-called oil vibration) resulting from the air bubbles contained in the oil or turbulence of oil flow occurs. It is therefore required not only to suppress the amount of air bubbles contained in the oil that is suctioned by the oil strainer to be small, but also to set the flow to the rectified state as much as possible.

In this respect, as a technique for suppressing the amount of air bubbles contained in the oil that is suctioned by the oil strainer to be small, in Japanese Published Unexamined Application No. 2011-12774, it is described that a recessed part is formed by recessing a bottom surface of a root portion of a suction tube in the main body of the oil strainer and the bottom surface of the recessed part is located at a higher position than other bottom surfaces of the main body. In this oil strainer, by locating the bottom surface of the recessed part at a higher position than other bottom surfaces of the main body, the air bubbles contained in the oil on the bottom surface side of the main body are likely to gather in the recessed part. It is therefore possible to inhibit the air bubbles staying on the bottom surface side of the main body from moving past the recessed part toward a suction port and to suppress the suction of air bubbles from the suction port.

However, in the case where the oil stirred by the rotation of the gear directly flows into the suction port, the oil strainer described in Japanese Published Unexamined Application No. 2011-12774 does not have a structure capable of fully blocking the flow of oil that directly flows into the suction port. Accordingly, it is contemplated that there is room for further improvement in the constitution for inhibiting the oil stirred by the rotation of the gear from directly flowing into the suction port of the strainer.

### SUMMARY

According to one aspect of the present invention, an oil strainer provided in an oil storage part that stores oil and adapted to suction and strain the oil in the oil storage part includes a main body which houses a filtering member therein, a tubular-shaped suction section protruding downward from a bottom surface of the main body and provided at its lower end with a suction port adapted to suction oil, and a partition section protruding downward from the bottom surface of the main body, wherein the partition section is located at a position apart from the suction port.

According to another aspect of the present invention, an oil strainer includes a main body, a tubular suction protrusion, and a partition. The main body has a bottom and is configured to filter an oil in an oil storage. The tubular suction protrusion protrudes from the bottom of the main body downward in a height direction along a height of the oil storage and has a suction port at a bottom end of the tubular suction protrusion. The main body is configured to suction the oil in the oil storage via the suction port. The partition protrudes downward in the height direction from the bottom of the main body and is provided apart from the suction port.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a principal cross-sectional view of a power transmission device provided with an oil strainer according to a first embodiment of the present invention;

FIG. 2 is a cross-sectional view of the power transmission device when seen from a rear side of a vehicle;

FIGS. 3A and 3B are views showing the external appearance shape of the oil strainer;

FIG. 4 is a partially enlarged view showing the oil strainer and its peripheral constitution;

FIG. 5 is a partially enlarged view showing the oil strainer and its peripheral constitution;

FIGS. 6A and 6B are views showing the external appearance shape of an oil strainer according to a second embodiment of the present invention; and

FIG. 7 is a principal cross-sectional view of a power transmission device provided with the oil strainer according to the second embodiment of the present invention.

### DESCRIPTION OF THE EMBODIMENTS

The embodiments will now be described with reference to the accompanying drawings, wherein like reference numerals designate corresponding or identical elements throughout the various drawings.

Preferable embodiments of the present invention will now be described in detail below referring to the accompanying drawings.

### First Embodiment

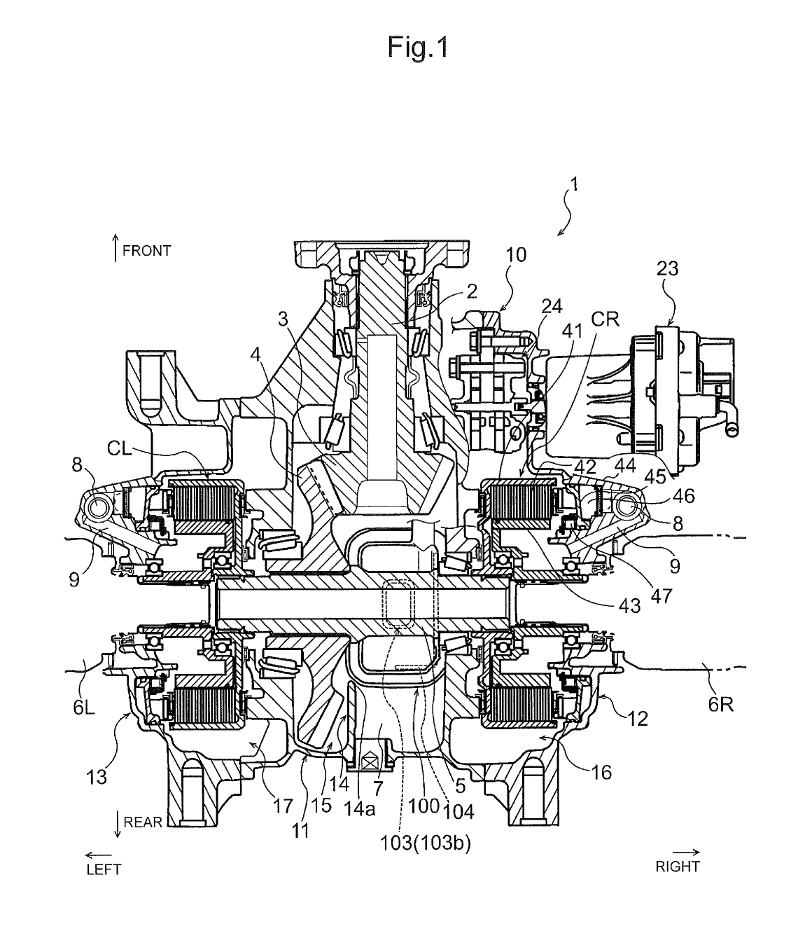

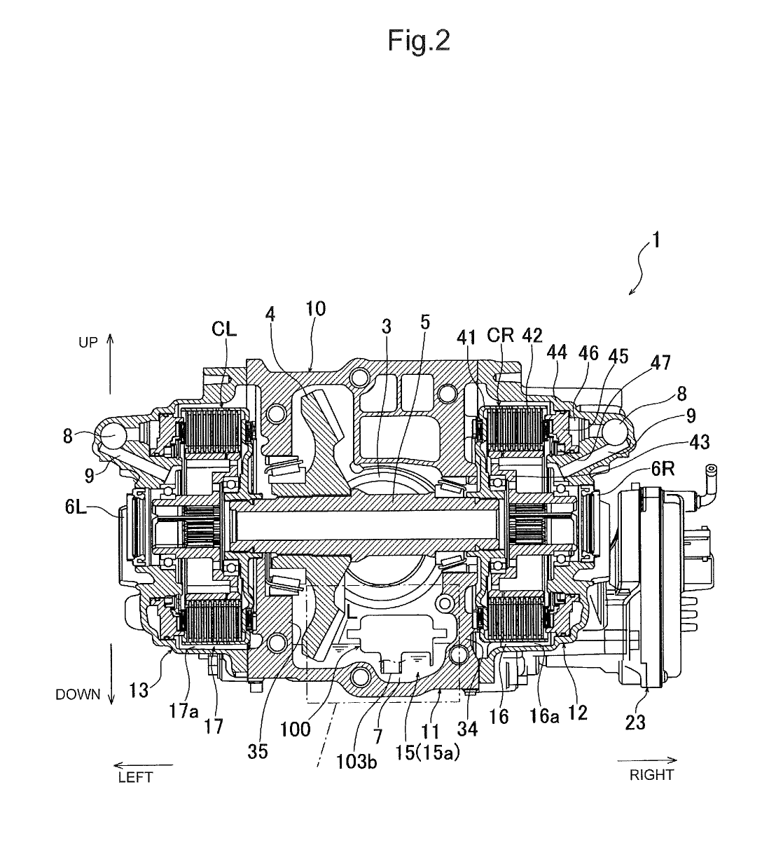

FIG. 1 is a principal cross-sectional view (planar cross-sectional view) showing a power transmission device provided with an oil strainer according to a first embodiment of the present invention. Also, FIG. 2 is a cross-sectional view of the power transmission device when seen from a rear side of a vehicle. The power transmission device 1 shown in these figures is composed of a differential mechanism for distributing the rotation of a driving source (not shown) such as an engine which is provided in the vehicle (an automobile) to right and left driving wheels (not shown). It is to be noted that the direction of arrows such as a front side, a rear side, a left side, a right side, a top side, or a bottom side shown in each figure shows the front side, the rear side, the left side, the right side, the top side or the bottom side in a condition in which the power transmission device 1 is mounted on the vehicle, or in a condition in which the oil strainer 100 described later is mounted on the power transmission device 1 and when referred to as the front, rear, left, right, top and bottom in the following description, it indicates each direction in those conditions.

The power transmission device 1, as shown in FIG. 1, is provided with a pinion shaft (a driving shaft) 2 driven to rotate by a driving force transmitted from a driving source, a pinion gear (a hypoid pinion gear) 3 serving as a driving gear formed at the tip of the pinion shaft 2, and a ring gear (a hypoid ring gear) 4 serving as a driven gear meshed with the pinion gear 3.

Further, the ring gear 4 is installed on the outer periphery of a hollow rotary input shaft 5 which is coaxially located on a left axle shaft 6L and a right axle shaft 6R. Accordingly, when the pinion shaft 2 is driven to rotate by the driving force from the driving source, the driving force is transmitted to the rotary input shaft 5 through the pinion gear 3 and the ring gear 4 to rotate the rotary input shaft 5. In the meanwhile, the ring gear 4 is a final reduction gear which transmits the finally reduced rotation to the rotary input shaft 5 adapted to input rotation on the left axle shaft 6L and the right axle shaft 6R in a passage transmitting the driving force from the driving source to the left axle shat 6L and the right axle shaft 6R on which a driving wheel is provided respectively.

In the rotary input shaft 5, on the end section of the side on which the ring gear 4 is installed, a left clutch CL is provided between the rotary input shaft 5 and the left axle shaft 6L to transmit the driving force, while on the opposite end section, a right clutch CR is provided between the rotary input shaft 5 and the right axle shaft 6R to transmit the driving force. In this manner, rotation of the rotary input shaft 5 is transmitted to the left clutch CL and the right clutch CR. And, a casing 10 of the power transmission device 1 is provided with a main casing (a casing) 11 located in the center in the axial direction (the vehicle width direction) of the rotary input shaft 5, a right casing 12 installed on the right side of the main casing 11, and a left casing 13 installed on the left side of the main casing 11. And, formed within the main casing 11 is a gear chamber 15 located in the center in the axial direction of the rotary input shaft 5. Also, respectively formed within the right and left casings 12, 13 is a pair of clutch chambers 16, 17 located on both sides of the gear chamber 15. With this arrangement, the casing 10 of the power transmission device 1 is formed to have a three-division chamber structure which is provided with the gear chamber 15 and the pair of clutch chambers 16, 17.

Installed in the gear chamber 15 are the pinion gear 3 and the ring gear 4, and allocated respectively in the right and left clutch chambers 16, 17 are the left clutch CL and the right clutch CR. The right clutch CR within the clutch chamber (the right clutch chamber) 16 on the right side are provided with a substantially cylindrical clutch housing 41 connected to an end section of the rotary input shaft 5, a clutch hub 43 spline-connected to an end section of the right axle shaft 6R on the inner peripheral side of the clutch housing 41, and a friction engagement section 42 having a structure in which a plurality of frictional materials are alternately laminated along the axial direction within the clutch housing 41. Further, provided at a position adjacent to the friction engagement section 42 are a piston housing 44 which is integrally formed with the right casing 12, a cylinder piston 45 housed within the piston housing 44, and a return spring 47 adapted to energize the cylinder piston. Formed within the piston housing 44 is a piston chamber 46 adapted to introduce the oil between the cylinder piston 45 and the piston housing 44.

Also, a pressure regulation valve 8 is provided to regulate the pressure of oil flowing from the piston chamber 46 of the right clutch CR. The pressure regulation valve 8 is a linear solenoid valve. The pressure regulation valve 8 is located adjacent to the outside of the piston chamber 46 of the right clutch CR. Accordingly, an oil passage from the piston chamber 46 to the pressure regulation valve 8 is provided at a shortest distance. Also, formed within the right casing 12 is a lubricating oil passage 9 adapted to introduce the oil discharged from the pressure regulation valve 8 to the inside of the right clutch CR. It is to be noted that a detailed description and imparting of a part of reference numerals are omitted, but the left clutch CL and its vicinity have the same constitution as that of the right clutch CR and its vicinity.

Formed at the bottom section 15a of the gear chamber 15 is an oil storage part 7 capable of storing the oil. An oil strainer 100 is installed in the oil storage part 7. The oil strainer 100 has, at the lower end, a suction port 103b for suctioning the oil and the oil gathered in the oil storage part 7 is suctioned from this suction port 103b. A detailed structure of the oil strainer 100 will be described later. Also, the ring gear 4 installed within the gear chamber 15 is provided in such a manner that at least the part of it is immersed in the oil stored in the oil storage part 7. More specifically, the ring gear 4 is provided so that at least part of it is situated in the lower position than the oil level L (see FIG. 2) in the oil storage part 7. In this manner, the oil (oil level) within the oil storage part 7 is stirred by the rotation of the ring gear 4.

Further, as shown in FIG. 2, the casing 10 has partition wall sections 34, 35 which are respectively provided between the central gear chamber 15 and the right and left clutch chambers 16, 17. Also, a communication hole (a communication passage) (not shown) is respectively formed at the lower end of or in the vicinity of the partition wall sections 34, 35. These communication holes are provided to respectively communicate with the bottom section 15a (the oil storage part 7) of the gear chamber 15 separated by the partition wall sections 34, 35 and the bottom sections of the right and left clutch chambers 16, 17.

In the right clutch CR with such a configuration, when the oil is introduced into the piston chamber 46 within the piston housing 44 by the operation of an oil pump 24, the cylinder piston 45 receiving pressure from the piston chamber 46 moves along the axial direction to the friction engagement section 42 side. With this, the friction engagement section 42 is pressed by the cylinder piston 45 to cause plates of the friction engagement section 42 to engage with each other, thereby fastening the right clutch CR. Meanwhile, when the oil is discharged from the piston chamber 46, the cylinder piston 45 is caused to move along the axial direction to the side apart from the right clutch CR by the energizing force of the return spring 47. Thus, the pressing force to the friction engagement section 42 is eased to release fastening of the right clutch CR. It is to be noted that the operation of the left clutch CL can also be conducted in the same manner as described above.

And, when engagement of the left clutch CL is performed while rotary input shaft 5 is rotating, the rotary input shaft 5 and the left axle shaft 6L are connected and the left axle shaft 6L is driven to rotate. Also, when engagement of the right clutch CR is performed while the rotary input shaft 5 is rotating, the rotary input shaft 5 and the right axle shaft 6R are connected and the right axle shaft 6R is driven to rotate.

At this time, the oil sucked up by the oil pump 24 is filled into the piston chamber 46 from an inlet port (not shown) of the piston housing 44 and discharged from an outlet port (not shown). The oil discharged from the outlet port is regulated by the pressure regulation valve 8. The oil regulated by the pressure regulation valve 8 is introduced into the right clutch chamber 16 through the lubricating oil passage 9. Since this oil is stirred by the rotation of the clutch hub 43, lubrication and cooling are performed to each part of the right clutch CR within the right clutch chamber 16.

Further, the oil used to lubricate and cool the right clutch CR drips (flows) from the right clutch CR down into the right clutch chamber 16 and accumulates at the bottom section. The oil accumulated at the bottom section of the right clutch chamber 16 is discharged through the communication hole (a discharge hole) of the partition wall section 34 to the oil storage part 7 of the central gear chamber 15. The oil accumulated at the oil storage part 7 is suctioned into the oil strainer 100 and sent to a downstream side. The flow of oil with respect to the left clutch CL is the same as in the case of the right clutch CR described above.

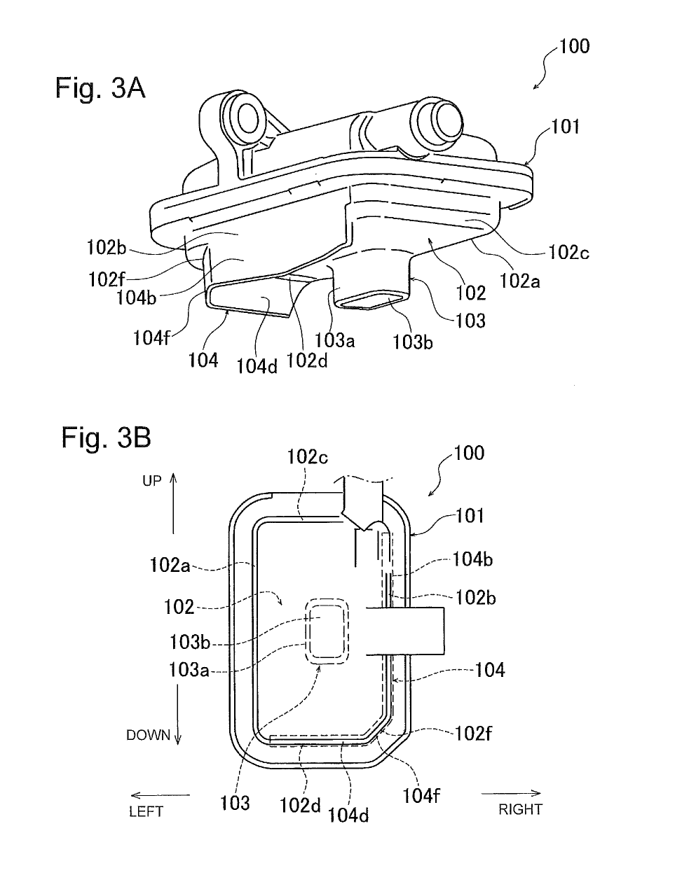

FIGS. 3A and 3B are views showing the external appearance shape of the oil strainer 100, wherein FIG. 3A is a perspective view and FIG. 3B is a plan view (top view). As shown in the figure, the oil strainer 100 is provided with a hollow container-shaped main body 101 adapted to house a filtering member (not shown) for straining the oil therein and a tubular-shaped suction section (a tubular suction protrusion) 103 protruding downward from the bottom surface 102 of the main body 101.

The bottom surface 102 of the main body 101 is formed in a substantially rectangular shape having a pair of long sides 102a, 102b and a pair of short sides 102c, 102d which form the outer circumferential edge. In a state in which the oil strainer 100 is installed within the gear chamber 15 (the oil storage part 7), the long sides 102a, 102b of the bottom surface 102 are provided to extend along the front and rear direction, while the short sides 102c, 102d are provided to extend along the right and left direction. In other words, the longitudinal direction of the bottom surface 102 of a substantially rectangular shape is located to be the front and rear direction (see FIG. 1).

As shown in FIG. 3B, the suction section 103 is located almost in the center of the bottom surface 102 of the main body 101. This suction section 103 is provided with a tubular section 103a formed in a hollow tubular shape extending downward (directly below) from the bottoms surface 102 of the main body 101 and a suction port 103b provided at the lower end of the tubular section 103a to suction the oil into the main body 101.

Also, the oil strainer 100 is provided with a plate-shaped partition plate (a partition section, a partition) 104 protruding downward from the bottom surface 102 of the main body 101. The partition plate 104 is integrally provided with a first flat plate section 104b of a flat plate shape extending along one long side 102b which is the right outer edge of the bottom surface 102, a second flat plate section 104d of a flat plate shape extending along one short side 102d which is the rear outer edge, and a connecting section (a corner section) 104f connecting the first flat plate section 104b and the second flat plate section 104d in a curved surface shape in a corner section 102f between these long and short sides 102b, 102d. In other words, the partition plate 104 is formed in a substantially L-shaped plate shape when seen from the lower part of (from a position directly below) the main body 101. This partition plate 104 is provided in such a manner that the surface (the inner surface) of the first flat plate section 104b and the surface (the inner surface) of the second flat plate section 104d are located to face the suction section 103 and the suction port 103b (the center of the bottom surface 102) and the whole partition plate is located to surround two directions of the right and lower sides of the suction port 103b. It is to be noted that the main body 101 including the partition plate 104 and the suction section 103 of the oil strainer 100 of the present embodiment is an integral molding of synthetic resins.

In the oil strainer 100 of the present embodiment, by providing the partition plate 104 protruding downward from the bottom surface 102 of the main body 101 and locating the partition plate 104 at a position apart from the suction port 103b, even in the case where air bubbles are contained in the oil entering the bottom surface 102 side of the main body 101 within the oil storage part 7 to be suctioned from the suction port 103b, it is possible to separate the air bubbles contained in the oil by the partition plate 104 which is located in the middle of the flow of oil. Accordingly, an amount of the air bubbles contained in the oil flowing past the partition plate 104 toward the suction port 103b can be suppressed to be small. Also, by locating the partition plate 104 in the middle of the flow of oil entering the bottom surface 102 side of the main body 101 to be suctioned from the suction port 103b and locating this partition plate 104 at a position apart from the suction port 103b, it is also possible to rectify the flow of oil flowing into the suction port 103b by the partition plate 104. With these arrangements, since it is possible to inhibit the oil (which contains the air bubbles and turbulence of flow is caused) stirred by the rotation of the ring gear 4 from directly flowing into the suction port 103b, occurrence of abnormal vibration or pulsation (oil vibration) in the oil pump 24 to which the oil from the oil strainer 100 is supplied can be effectively prevented.

Also, in the oil strainer 100 of the present embodiment, the suction section 103 is located almost in the center of the bottom surface 102 of the main body 101, while the partition plate 104 is provided along the outer edge (the long side 102b and short side 102d) of the bottom surface 102. According to this constitution, since the suction port 103b can be sufficiently separated from the partition plate 104 with a simple constitution, it is not only possible to effectively separate the air bubbles contained in the oil flowing into the suction port 103b, but alto to effectively rectify the flow of oil flowing into the suction port 103b.

Further, in the oil strainer 100 of the present embodiment, the partition plate 104 is integrally formed of the same material (synthetic resins) as that of the main body 101. With this, despite the constitution capable of suppressing the amount of air bubbles contained in the oil that is suctioned from the suction port 103b, it is possible to realize structural simplification and a light weight by reducing the number of component parts of the oil strainer 100. It is also possible to realize easy manufacturing of the oil strainer 100.

Still further, in the oil strainer 100 of the present embodiment, the partition plate 104 is formed in a plate shape extending along the outer edge (the long side 102b and the short side 102d) of the bottom surface 102 to surround the right and rear sides forming part of the circumference of the suction port 103b. In this manner, by forming the partition plate 104 in the shape surrounding two directions of the right and rear sides forming part of the circumference of the suction port 103b, it is not only possible to rectify the oil flowing into the suction port 103b from plural directions, but also to effectively prevent the air bubbles from reaching the suction ports 103b by separating the air bubbles contained in the oil.

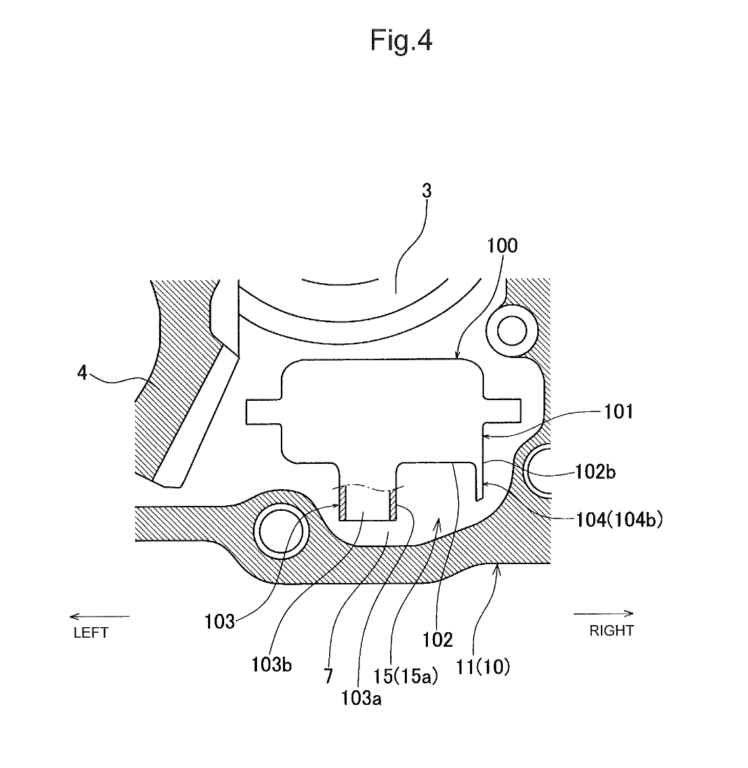

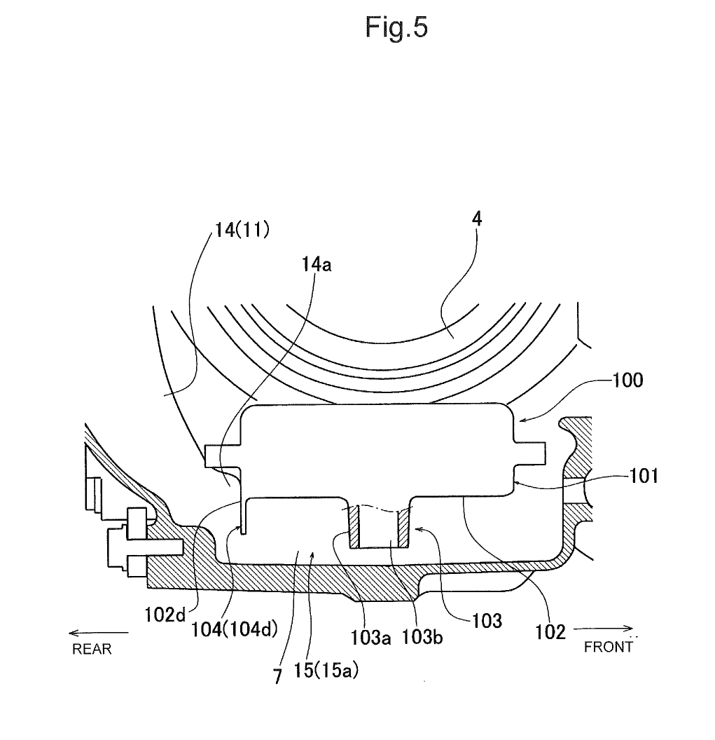

FIGS. 4 and 5 are partially enlarged views showing a detailed constitution of the oil strainer 100 and its periphery, in which FIG. 4 is a view of the oil strainer 100 and its periphery when seen from the rear side (an enlarged view of an X part in FIG. 2) and FIG. 5 is a view of the oil strainer 100 and its periphery when seen from the right side. In FIGS. 4 and 5, description of the oil level L of the oil storage part 7 is omitted.

As shown in FIGS. 1 and 5, formed at a section opposite to the corner section 102g on the left rear side (of the bottom surface 102) of the oil strainer 100 (the main body 101) within the inner surface of the gear chamber 15 of the main casing 11 is a rib 14 including a plate-shaped protrusion protruding forward. The rib 14 is located between the ring gear 4 and the suction port 103b of the oil strainer 100 and its tip section 14a is provided to come in contact with the main body 101 of the oil strainer 100. With this arrangement, an area (the area more to the left side than the rib 14 in FIG. 1) in which the ring gear 4 within the oil storage part 7 is located and an area (the area more to the right side than the rib 14 in FIG. 1) in which the suction port 103b of the oil strainer 100 is located are in a state separated by the rib 14.

In this manner, by providing the rib 14 between the ring gear 4 and the suction port 103b of the oil strainer 100, it is possible to effectively inhibit the oil containing a lot of air bubbles as a result of oil flow turbulence caused by the rotation of the ring gear 4 from directly flowing into the suction port 103b. Thus, the amount of air bubbles contained in the oil that is suctioned from the suction port 103b can be suppressed to be small. It is also possible to more effectively rectify the oil that is suctioned from the suction port 103b. Through these, it is possible to more effectively prevent the occurrence of the vibration or pulsation (oil vibration) in the oil pump 24. Further, owing to the configuration using the rib 14 that is part of the casing 11 of the power transmission device 1, it is possible to get the above-mentioned effects while simplifying the configuration by suppressing the increase of the number of parts of the power transmission device 1.

Further, by causing the tip section 14a of the rib 14 to come into contact with the oil strainer 100 (the main body 101), it is possible to surely separate the area in which the ring gear 4 within the oil storage part 7 is located from the area in which the suction port 103b of the oil strainer 100 is located by the rib 14. Thus, it is possible to effectively block a passage in which the oil containing a lot of air bubbles as a result of flow turbulence caused by the rotation of the ring gear 4 directly flows into the suction port 103b.

Specifically in the present embodiment, since the ring gear 4 that is a final reduction gear is large, there is a tendency in which the oil within the oil storage part 7 stirred by the rotation contains a lot of air bubbles and large turbulence of oil flow occurs. Therefore, though there is a high probability that vibration or pulsation will occur in the oil pump 24, owing to the provision of the rib 14 for separating between the ring gear 4 and the suction port 103b, it is possible to obtain a good effect of preventing the occurrence of vibration or pulsation in the oil pump 24 since the passage in which the oil containing a lot of air bubbles as a result of flow turbulence caused by the rotation of the ring gear 4 as described above directly flows into the suction port 103b can be effectively blocked.

### Second Embodiment

Next, the oil strainer according to a second embodiment of the present invention will now be described. It is to be noted that, in the description of the second embodiment and a corresponding drawing, the component parts which are the same as or correspond to the first embodiment are given the same reference numerals and the detailed description thereof is omitted. Also, matters other than the matters described hereunder are the same as in the first embodiment.

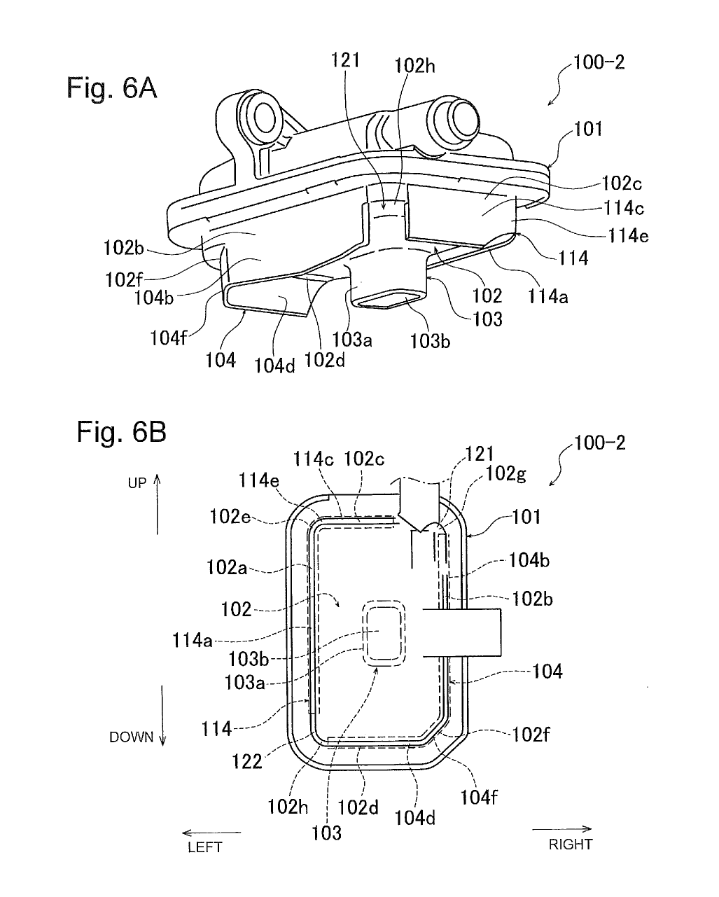

FIGS. 6A and 6B are figures showing the external appearance configuration of an oil strainer 100-2 according to the second embodiment of the present invention, in which FIG. 6A is a perspective view and FIG. 6B is a plan view. The oil strainer 100-2 of the present embodiment is provided with another partition plate 114 formed on the bottom surface of the main body in addition to the partition plate 104 provided in the oil strainer 100 of the first embodiment. The partition plate 104 is hereinafter referred to as a first partition plate 104, while the partition plate 114 is referred to as a second partition plate 114.

As in the case of the first partition plate 104, the second partition plate 114 is a plate-shaped member (section) protruding downward from the bottom surface 102 of the main body 101. The second partition plate 114 is integrally provided with a first flat plate section 114a of a flat plate shape extending along another long side 102a that is a left side outer edge of the bottom surface 102 of the main body 101, a second flat plate section 114c of a flat plate shape extending along another short side 102c that is a front side outer edge, and a connecting section (a corner section) adapted to connect the first flat plate section 114a and the second flat plate section 114c in a curved surface shape in a corner section 102e between these long and short sides 102a, 102c. In other words, the second partition plate 114 is formed in an inverted substantially L-shaped plate shape (in a planar view) when seen from the lower part of (from a position directly below) the main body 101. This second partition plate 114 is provided in such a manner that the surface (the inner surface) of the first flat plate section 114a and the surface (inner surface) of the second flat plate section 114c are located to face the suction section 103 and the suction port 103b (the center of the bottom surface 102) and the whole partition plate is located to surround two directions of the right and front sides of the suction port 103b.

In other words, the second partition plate 114 is located almost symmetrically (point symmetry) with respect to the first partition plate 104 and the center of the bottom surface 102 of the main body 101. And, formed between the first partition plate 104 and the second partition plate 114 are a gap 121 provided in upper right corner section 102g of the bottom surface 102 and a gap 122 provided in lower left corner section 102h of the bottom surface 102. As for the periphery of the suction port 103b, only the sections of these gaps 121, 122 are left open and other sections are in surrounded condition.

In other words, according to the oil strainer 100-2 of the present embodiment, four sides of the front and rear sides and the left and right sides and two corner sections of the upper left and the lower right corners, of the circumference of the suction port 103b, are surrounded by the first partition plate 104 and the second partition plate 114, while the gaps 121, 122 are respectively formed in the upper right and lower left corner sections.

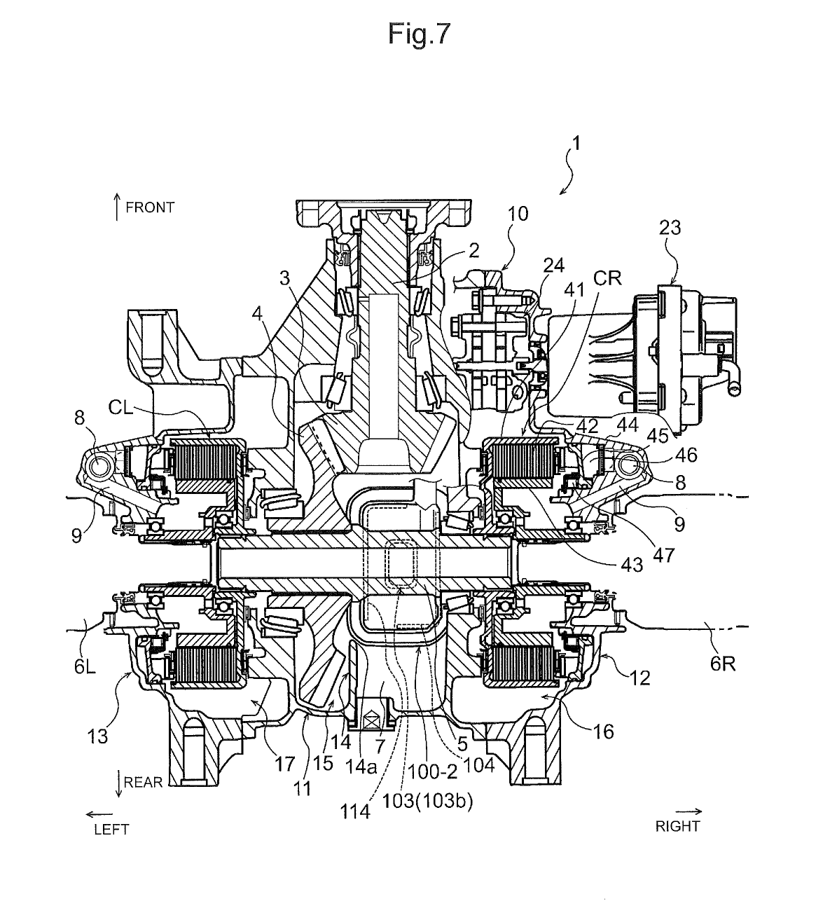

FIG. 7 is a principal cross-sectional view of the power transmission device 1 provided with the oil strainer 100-2. As shown in the figure, the second partition plate 114 of the oil strainer 100-2 is located between the ring gear 4 and the suction port 103b of the oil strainer 100-2 within the oil storage part 7. Since part of the ring gear 4 is immersed in the oil within the oil storage part 7, there is a tendency in which the oil in the oil storage part 7 is stirred by the rotation of the ring gear 4 to cause the turbulence of flow and the air bubbles contained in the oil increase. However, in the present embodiment, since the second partition plate 114 of the oil strainer 100-2 is located between the ring gear 4 and the suction port 103b of the oil strainer 100-2, it is possible to effectively inhibit the oil in which a lot of air bubbles are contained from directly flowing into the suction port 103b as a result of turbulence of flow caused by the rotation of the ring gear 4. Thus, the amount of air bubbles contained in the oil that is suctioned from the suction port 103b can be suppressed to be small. It is also possible to rectify the oil that is suctioned from the suction port 103b. Through these, occurrence of vibration or pulsation of oil (oil vibration) in the oil pump 24 can be effectively prevented.

Further, in the present embodiment, by locating the rib 14 of the casing 11 in addition to the second partition plate 114 of the oil strainer 100-2 between the ring gear 4 and the suction port 103b, it is possible to more effectively inhibit the oil in which a lot of air bubbles are contained as a result of oil flow turbulence caused by the rotation of the ring gear 4 from directly flowing into the suction port 103b. Accordingly, the amount of air bubbles contained in the oil to be suctioned from the suction port 103b can be suppressed to be smaller. Further, the oil to be suctioned from the suction port 103b can also be rectified more effectively.

Still further, in the oil strainer 100-2 of the present embodiment, four sides of the front and rear sides and the left and right sides and two corner sections of the upper left and lower right sections, of the circumference of the suction port 103b, are surrounded by the first partition plate 104 and the second partition plate 114, while the gaps 121, 122 are formed in the upper right and lower left corners. According to this constitution, though the air bubbles contained in the oil flowing into the suction port 103b can be separated by the first partition plate 104 and the second partition plate 114 and the oil flow can be rectified, it is possible to secure the flow of oil (flow of the necessary amount) flowing into the suction port 103b by the gaps 121, 122. Accordingly, though the oil strainer 100-2 has a configuration capable of separating the air bubbles contained in the oil by rectifying the oil flowing into the suction port 103b, it also has a structure capable of preventing the amount of oil to be suctioned from the suction port 103b from running short.

While preferable embodiments of the present invention have been shown and described above, the present invention is not limited to the above embodiments and various modifications and substitutions may be made within the scope of patent claims and technical ideas described in the description and drawings. For examples, the power transmission device according to the embodiment of the present invention is not limited to a differential mechanism adapted to distribute a driving force from a driving source shown in the above embodiments and to transmit it to driving wheels, but it may be a transmission that changes and transmits the rotation by power from the driving source. In that case, the oil strainer according to the embodiment of the present invention is an oil strainer installed in the oil storage part which is provided at the bottom section of the casing of the transmission.

Further, in the embodiments stated above, a case where the tip section 14a of the rib 14 of the casing 11 comes in contact with the main body 101 of the oil strainer 100 is shown, but the tip section of the rib doesn't always have to come in contact with the oil strainer as far as the rib is located between the gear and the suction port of the oil strainer.

Still further, in the above embodiments, a case where the partition plate (the partition section) 104 (114) is provided along the outer edge of the bottom surface 102 of the main body 101 is shown, but the partition section provided in the oil strainer according to the embodiment of the present invention may be provided in the vicinity of the outer edge of the bottom surface of the main body (e.g.; on the inside near the outer edge).

In order to solve the problems, according to the embodiment of the present invention, an oil strainer (100) provided in an oil storage part (7) that stores oil and adapted to suction and strain the oil in the oil storage part comprises a main body (101) which houses

a filtering member therein, a tubular-shaped suction section (103b) protruding downward from a bottom surface (102) of the main body and provided at its lower end with a suction port (103b) adapted to suction oil, and a partition section (104) protruding downward from the bottom surface of the main body, wherein the partition section is located at a position apart from the suction port.

In the oil strainer according to the embodiment of the present invention, since the partition section protruding downward from the bottom surface of the main body is provided and this partition section is located at a position apart from the suction port, even in the case where air bubbles are contained in the oil entering the bottom surface side of the main body within the oil storage part to be suctioned from the suction port, it is possible to separate the air bubbles contained in the oil by the partition section which is located in the middle of the oil flow. Accordingly, an amount of air bubbles contained in the oil flowing past the partition section toward the suction port can be suppressed to be small. Further, by locating the partition section in the middle of flow of the oil entering the bottom surface side of the main body to be suctioned from the suction port and by locating this partition section at a position apart from the suction port, the flow of oil flowing into the suction port can also be rectified. For these reasons, since it is possible to inhibit the oil stirred by the rotation of the gear from directly flowing into the suction port, the occurrence of abnormal vibration or pulsation in the oil pump to which oil from the oil strainer is supplied can be effectively prevented.

Further, in the oil strainer, the suction section is located almost in the center of the bottom surface of the main body and the partition section may be located at the outer edge of the bottom surface or in its vicinity. According to this constitution, since the suction port can be sufficiently separated from the partition section with a simple constitution, it is not only possible to effectively separate the air bubbles contained in the oil flowing into the suction port, but also to effectively rectify the flow of oil flowing into the suction port.

Still further, in the oil strainer, the partition section may also be integrally formed of the same material as that of the main body. With this, despite the constitution in which an amount of air bubbles contained in the oil to be suctioned from the suction port can be suppressed to be small, it is possible to realize structural simplification and weight reduction of the oil strainer by reducing the number of the component parts of the oil strainer. It is also possible to realize easy manufacturing of the oil strainer.

Further, in the oil strainer, the partition section may be formed into a plate shape extending along the outer edge or its vicinity of the bottom surface to surround at least part of a circumference of the suction port. According to this constitution, by forming the partition section into a shape surrounding at least part of the circumference of the suction port, it is not only possible to rectify the oil flowing into the suction port from plural directions, but also to effectively prevent the air bubbles from reaching the suction port by separating the air bubbles contained in the oil.

Also, according to the embodiment of the present invention, a power transmission device is provided which comprises a casing (11), a gear provided in the casing, and an oil strainer provided in the casing, wherein the oil storage part is provided at the bottom section of the casing, the gear is provided in such a manner that at least part of it is immersed in the oil in the oil storage part, and the partition section of the oil strainer is located between the gear and the suction port.

According to the power transmission device of the embodiment of the present invention, since the gear is provided in such a manner that at least part of it is immersed in the oil in the oil storage part, there is a tendency that the oil in the oil storage part is stirred by the rotation of the gear to cause turbulence of the oil flow and the amount of air bubbles contained in the oil tends to increase. However, in the embodiment of the present invention, by locating the partition section of the oil strainer between the gear and the suction port, it is possible to effectively inhibit the oil containing a lot of air bubbles as a result of turbulence of the oil flow caused by the rotation of the gear from directly flowing into the suction port. Thus, the amount of air bubbles contained in the oil that is suctioned from the suction port can be suppressed to be small. It is also possible to rectify the oil that is suctioned from the suction port. For these reasons, it is possible to effectively prevent the occurrence of vibration or pulsation of the oil in the oil pump or the like to which the oil from the oil strainer is supplied.

Further, in the power transmission device, the casing can be provided with a rib (14) which is located between the gear and the suction port. With this arrangement, by locating the rib of the casing of the power transmission device in addition to the partition section of the oil strainer between the gear and the suction port, it is possible to more effectively inhibit the oil in which a lot of air bubbles are contained as a result of turbulence of the flow caused by the rotation of the gear from directly flowing into the suction port. Thus, the amount of air bubbles contained in the oil that is suctioned from the suction port can be suppressed to be smaller. Also, it is possible to more effectively rectify the oil that is suctioned from the suction port. For these reasons, it is possible to more effectively prevent the occurrence of the vibration or pulsation in the oil pump to which the oil from the oil strainer is supplied. Further, owing to the structure using the rib which is part of the casing of the power transmission device, it is possible to obtain the above-mentioned effects, while realizing structural simplification by suppressing an increase in the number of parts of the power transmission device.

Still further, in the power transmission device, the rib may also be provided in such a manner that the tip section abuts on the main body of the oil strainer. In this way, by causing the tip section of the rib to abut on the main body of the oil strainer, it is possible to more effectively block a passage in which the oil containing a lot of air bubbles directly flows into the suction port as a result of turbulence of oil flow caused by the rotation the gear.

It is to be noted that the reference numerals in parentheses show those of the corresponding component elements of the embodiments described above as an example of the present invention.

According to the oil strainer and the power transmission device of the embodiment of the present invention, since it is not only possible to inhibit the oil stirred by the rotation of the gear or the like from directly flowing into the suction port of the oil strainer, but also to suppress the amount of air bubbles contained in the oil to be small by rectifying the oil that is suctioned from the suction port, the abnormal vibration or pulsation (oil vibration) in the oil pump can be effectively prevented.

Obviously, numerous modifications and variations of the present invention are possible in light of the above teachings. It is therefore to be understood that within the scope of the appended claims, the invention may be practiced otherwise than as specifically described herein.

What is claimed is:

1. An oil strainer provided in an oil storage part that stores oil and adapted to suction and strain the oil in the oil storage part, comprising:
a main body adapted to house a filtering member therein;
a tubular-shaped suction section protruding downward from a bottom surface of the main body and provided at its lower end with a suction port adapted to suction oil; and
a partition section protruding downward from the bottom surface of the main body, wherein the partition section is located at a position apart from the suction port.

2. The oil strainer according to claim 1, wherein the suction port is located almost in the center of the bottom surface, while the partition section is located at the outer edge of the bottom surface or in its vicinity.

3. The oil strainer according to claim 1, wherein the partition section is integrally formed of the same material as that of the main body.

4. The oil strainer according to claim 1, wherein the partition section is formed into a plate shape extending along the outer edge or its vicinity of the bottom surface to surround at least part of a circumference of the suction port.

5. A power transmission device comprising:
a casing;
a gear provided in the casing; and
the oil strainer according to claim 1, provided in the casing,
wherein the oil storage part is provided at the bottom of the casing,
wherein the gear is provided in such a manner that at least part of it is immersed in the oil in the oil storage part, and
wherein the partition section of the oil strainer is located between the gear and the suction port.

6. The power transmission device according to claim 5, wherein the casing is provided with a rib located between the gear and the suction port.

7. The power transmission device according to claim 6, wherein the rib is provided to abut on the main body of the oil strainer.

8. An oil strainer comprising:
a main body having a bottom and being configured to filter an oil in an oil storage;
a tubular suction protrusion protruding from the bottom of the main body downward in a height direction along a height of the oil storage and having a suction port at a bottom end of the tubular suction protrusion, the main body being configured to suction the oil in the oil storage via the suction port; and
a partition protruding downward in the height direction from the bottom of the main body and being provided apart from the suction port.

9. The oil strainer according to claim 8, wherein the suction port is located substantially at a center of the bottom surface, while
the partition is located adjacent to the outer edge of the bottom surface.

10. The oil strainer according to claim 8, wherein the partition is integrally formed of the same material as that of the main body.

11. The oil strainer according to claim 8, wherein the partition has a plate shape extending along the outer edge of the bottom surface to surround at least part of a circumference of the suction port.

12. A power transmission device comprising:
a casing;
a gear provided in the casing; and
the oil strainer according to claim 1, provided in the casing,
wherein the oil storage is provided at the bottom of the casing,
wherein the gear is provided in such a manner that at least part of it is immersed in the oil in the oil storage, and
wherein the partition of the oil strainer is located between the gear and the suction port.

13. The power transmission device according to claim 12, wherein the casing is provided with a rib located between the gear and the suction port.

14. The power transmission device according to claim 13, wherein the rib is provided to abut on the main body of the oil strainer.
